(19) United States
(12) Patent Application Publication
(10) Pub. No.: US 2006/0150177 A1
(43) Pub. Date: Jul. 6, 2006

(54) Firmware update method and system

(75) Inventors: Hung-Ping Liu, Chungho (TW); Shun-Chin Lin, Chungli (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/301,689

(22) Filed: Dec. 13, 2005

(30) Foreign Application Priority Data
Dec. 30, 2004 (TW) 93141348

(51) Int. Cl. G06F 9/44

(52) U.S. Cl. 717/168

(57) ABSTRACT

An update method for firmware in an electronic device. A function of firmware update determination is verified for an electronic device. If the electronic device provides the firmware update determination function, an update program is sent thereto. The electronic device receives the update program for the firmware and determines if the firmware requires updating according to the update program. The electronic device updates the firmware using the update program if the firmware is determined to require updating.

### BACKGROUND

The invention relates to firmware update methods, and in particular to update methods and systems implemented by an electronic device for firmware therein.

With the technical progress of optical storage, firmware in hardware devices, such as disk drives or modems, requires periodic updating by programs.

Conventionally, the necessity for firmware update is determined by firmware update software in a host or a server, such as a personal computer host (PC host) or a server host. For example, if firmware in a CD-ROM drive requires updating, the CD-ROM drive is first connected to a host. Firmware update software in the host then determines if the firmware in the CD-ROM drive requires updating. If so, the firmware update software sends an update program to the CD-ROM drive. The CD-ROM drive then updates the firmware using the received update program.

Conventional methods reveal some drawbacks. For example, determination programs for multiple electronic devices are comprised in the firmware update software, increasing complexity thereof. Furthermore, if the firmware update software includes all information for the electronic devices, the information may be acquired without authorization and used improperly. Additionally, the increased amount of data may cause update errors. Thus, improved update methods and systems for firmware in an electronic device are desirable

### SUMMARY

Update methods for firmware in an electronic device are provided. An electronic device with firmware is directed to submit configuration information by firmware update software in a host. The firmware update software determines if the electronic device provides a firmware update determination function according to the configuration information. If the electronic device provides the firmware update determination function, an update program is sent thereto. The update program is processed by an encoding procedure. The electronic device receives the update program for the firmware and decodes the received update program using a decoding procedure corresponding to the encoding. The electronic device determines if the firmware requires updating according to the decoded update program by analyzing identification therein. The electronic device updates the firmware using the update program if the firmware requires updating.

### BRIEF DESCRIPTION OF DRAWINGS

Embodiments of the invention can be more fully understood by reading the subsequent detailed description and examples with references made to the accompanying drawings, wherein:

FIG. 1 is a flowchart of an embodiment of an update method for firmware in an electronic device.

FIG. 2 is a diagram of an embodiment of a machine-readable storage medium storing a computer program providing an update method for firmware in an electronic device.

FIG. 3 is a diagram of an embodiment of an update system for firmware in an electronic device.

FIG. 4 is a diagram of another embodiment of an update system for firmware in an electronic device.

FIG. 5 is a flowchart of an exemplary implementation of an update method for firmware in an electronic device.

### DETAILED DESCRIPTION

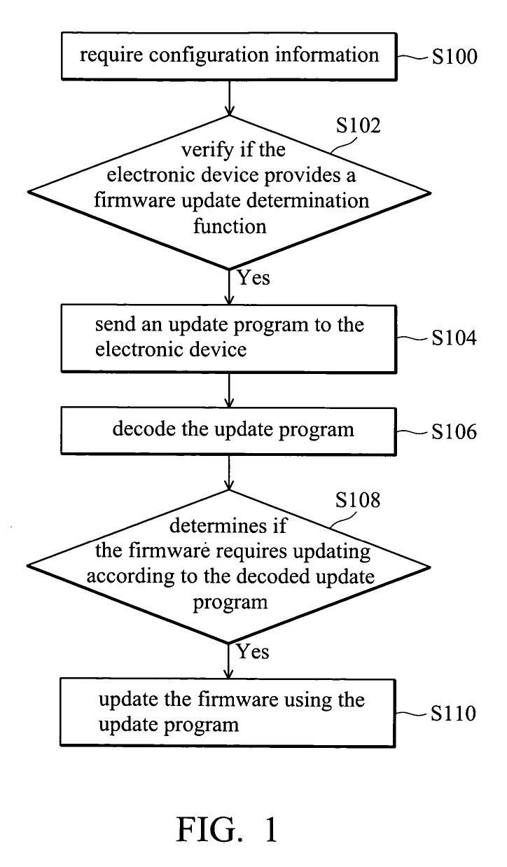

FIG. 1 is a flowchart of an embodiment of an update method for firmware in an electronic device. Firmware update software in a host directs an electronic device with firmware to provide configuration information (step S100). The firmware update software in the host then verifies if the electronic device provides a firmware update determination function based on the configuration information (step S102). The firmware update determination function enables determination of requirement for firmware update.

An update program processed by an encoding procedure is sent to the electronic device if the firmware update determination function is provided thereby (step S104). The electronic device receives the update program for the firmware.

Thereafter, the electronic device decodes the update program by a decoding procedure corresponding to the encoding procedure (step S106). The electronic device determines if the firmware requires updating according to the decoded update program (step S108). Determination of the firmware update is accomplished by searching identification in the decoded update program. The electronic device updates the firmware using the update program if the firmware is determined to be updated, that is, the identification is contained in the decoded update program (step S110).

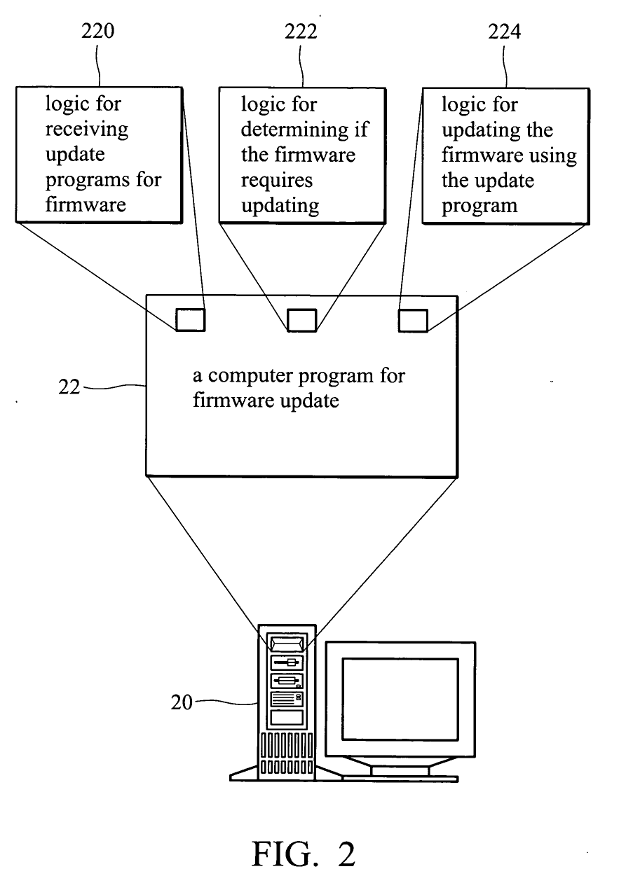

The method can be implemented in computer programs. FIG. 2 is a diagram of an embodiment of a machine-readable storage medium storing a computer program providing an update method for firmware in an electronic device. As shown in FIG. 2, machine-readable storage medium 20 stores a computer program 22. The computer program 22 mainly comprises logic receiving update programs for firmware 220, logic determining if the firmware requires updating 222, and logic updating the firmware using the update program 224.

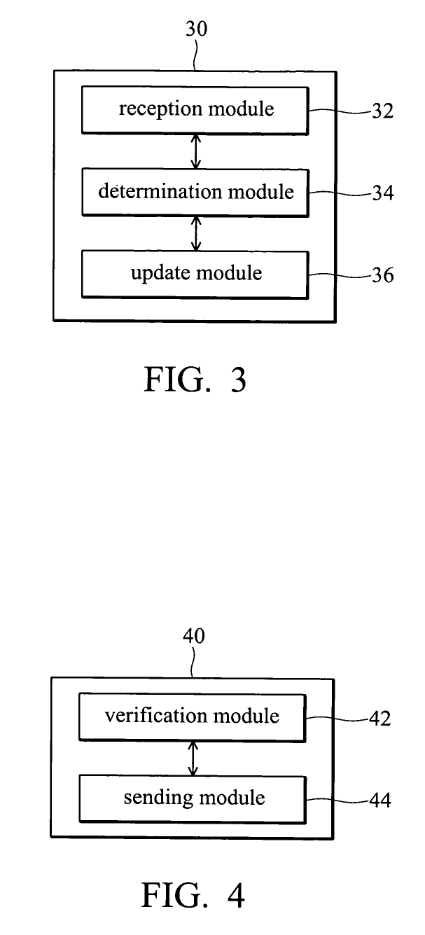

FIG. 3 is a diagram of an embodiment of an update system for firmware in an electronic device. An update system 30 for firmware in an electronic device comprises a reception module 32, a determination module 34, and an update module 36.

The reception module 32 receives an update program processed by an encoding procedure for the firmware. The determination module 34 decodes the update program using a decoding procedure corresponding to the encoding procedure.

The determination module 34 determines if the firmware requires updating according to the decoded update program. If so, update module 36 updates the firmware using the update program. The determination module 34 further analyzes identification in the decoded update program to determine the firmware update.

FIG. 4 is a diagram of another embodiment of an update system for firmware in an electronic device. An update system 40 for firmware in an electronic device comprises a verification module 42 and a sending module 44. The verification module 42 is coupled to the electronic device with firmware and verifies if the electronic device provides a function of firmware update determination. The firmware update determination function enables determination of the firmware update. The verification module 42 verifies firmware update determination function using configuration information sent by the electronic device.

The sending module 44 is coupled to the verification module 42 and sends the update program to the electronic device if the firmware update determination function is provided therein. The electronic device updates the firmware using the update program.

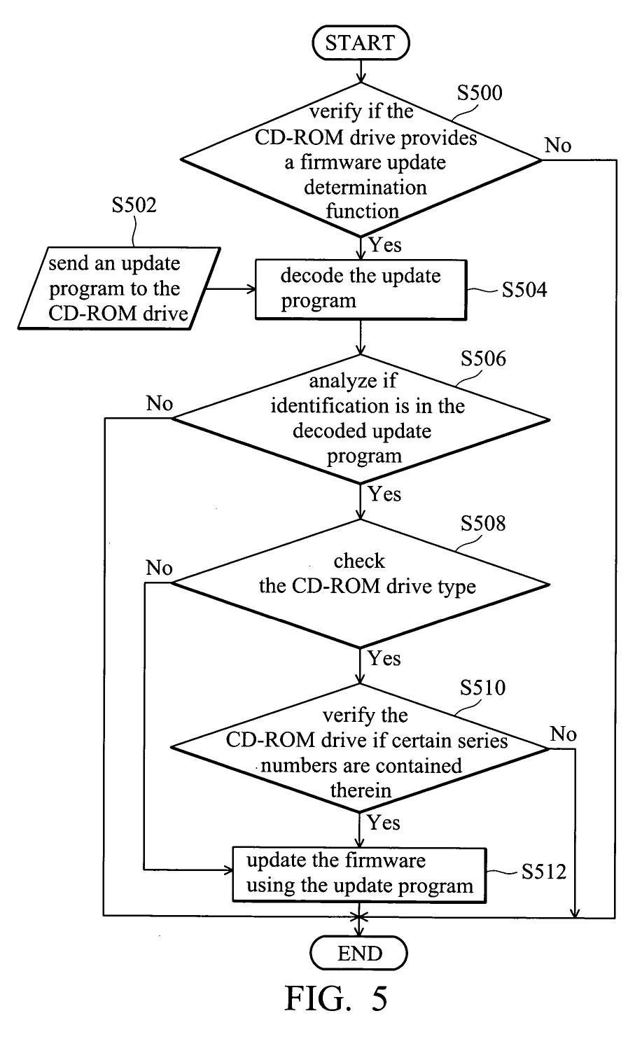

FIG. 5 is a flowchart of an exemplary implementation of an update method for firmware in an electronic device. In the embodiment, the update method is employed in a CD-ROM drive with firmware. Firmware update software in a host verifies if the CD-ROM drive provides a firmware update determination function (step S500). If the firmware update determination function is not provided by the CD-ROM drive, the process is terminated. If the CD-ROM drive provides the firmware update determination function, an update program is sent to the CD-ROM drive (step S502). The update program is processed by an encoding procedure. The CD-ROM drive then receives the update program.

The CD-ROM drive decodes the update program using a predetermined decoding procedure corresponding to the encoding procedure (step S504). Identification is analyzed in the decoded update program (step S506). If the identification is not contained in the decoded update program, the CD-ROM drive is deemed to not require an update and the process is terminated. Here, the identification can be a string, a particular code, or series numbers of the CD-ROM drive contained in the decoded update program in other location. When the update program is decoded, the decoded update program is compared to the stored identification to determine if the CD-ROM drive needs to be updated.

The CD-ROM drive updates the firmware using the update program if the firmware requires update, that is, the identification is contained in the decoded update program (step S512). The identification analysis can be divided into several levels to limit firmware update to only execution in specific CD-ROM drives. For example, after step S506, the CD-ROM drive type can be checked (step S508). The CD-ROM drive is further verified if certain series numbers are contained in the CD-ROM drive (step S510). If the CD-ROM drive is an electronic device with firmware to be updated, the firmware is updated using the update program (step S512).

Embodiments of the present invention provide update methods and systems for firmware in an electronic device. Firmware update programs can be varied by devices in identification, avoiding unexpected update program acquisition or firmware damage.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An update method for firmware in an electronic device, comprising:
the electronic device receiving an update program for the firmware;
the electronic device determining if the firmware requires updating according to the update program; and
the electronic device updating the firmware using the update program if the firmware is determined to require updating.

2. The update method for firmware in an electronic device as claimed in claim 1, wherein reception of the update program further comprises:
verifying if a firmware update determination function to enable determination of the firmware update is provided in the electronic device; and
sending the update program to the electronic device if the firmware update determination function is provided.

3. The update method for firmware in an electronic device as claimed in claim 2, wherein verification of the firmware update determination function is implemented by configuration information sent by the electronic device.

4. The update method for firmware in an electronic device as claimed in claim 1, wherein the update program is processed by an encoding procedure corresponding to a decoding procedure.

5. The update method for firmware in an electronic device as claimed in claim 4, wherein determination of the firmware update further decodes the update program by the decoding procedure.

6. The update method for firmware in an electronic device as claimed in claim 5, wherein determination of the firmware update further analyzes identification in the decoded update program.

7. A machine-readable storage medium storing a computer program providing an update method for firmware in an electronic device, comprising:
the electronic device receiving an update program for the firmware;
the electronic device determining if the firmware requires updating according to the update program; and
the electronic device updating the firmware using the update program if the firmware is determined to require updating.

8. The machine-readable storage medium as claimed in claim 7, wherein reception of the update program further comprises:
verifying if a firmware update determination function, enabling determination of the firmware update, is provided in the electronic device; and
sending the update program to the electronic device if the firmware update determination function is provided.

9. The machine-readable storage medium as claimed in claim 8, wherein verification of the firmware update determination function is implemented by configuration information sent by the electronic device.

10. The machine-readable storage medium as claimed in claim 7, wherein the update program is processed by an encoding procedure corresponding to a decoding procedure.

11. The machine-readable storage medium as claimed in claim 10, wherein determination of the firmware update further decodes the update program by the decoding procedure.

12. The machine-readable storage medium as claimed in claim 11, wherein determination of the firmware update further analyzes identification in the decoded update program.

13. An update system for firmware in an electronic device, comprising:
a reception module, receiving an update program for the firmware;
a determination module, coupled to the reception module, determining if the firmware requires updating according to the update program; and
an update module, coupled to the determination module, updating the firmware using the update program if the firmware is determined to require updating.

14. The update system for firmware in an electronic device as claimed in claim 13, wherein the update program is processed by an encoding procedure corresponding to a decoding procedure.

15. The update system for firmware in an electronic device as claimed in claim 14, wherein the determination module decodes the update program by the decoding procedure.

16. The update system for firmware in an electronic device as claimed in claim 15, wherein the determination module further analyzes identification in the decoded update program.

17. An update system for firmware in an electronic device, comprising:
a verification module, coupled to the electronic device, verifying if a firmware update determination function to enable determination of the firmware update is provided in the electronic device; and
a sending module, coupled to the verification module, sending the update program to the electronic device and the electronic device updating the firmware using the update program if the firmware update determination function is provided.

18. The update system for firmware in an electronic device as claimed in claim 17, wherein the verification module verifies the firmware update determination function by configuration information sent by the electronic device.
